(19) United States
(12) Patent Application Publication
(10) Pub. No.: US 2015/0012604 A1
(43) Pub. Date: Jan. 8, 2015

(54) INSTANT MESSAGING SERVICE BASED ON ITEM OF INTEREST TO USER

(71) Applicant: NCsoft Corporation, Seoul (KR)

(72) Inventors: Yun Suk LEE, Seoul (KR); Hee Kyong YOON, Seoul (KR); Dong Jin LEE, Seoul (KR)

(21) Appl. No.: 14/323,838

(22) Filed: Jul. 3, 2014

(30) Foreign Application Priority Data
Jul. 4, 2013 (KR) 10-2013-0078346

(51) Int. Cl. H04L 12/58; H04L 29/08; H04L 12/18

(52) U.S. Cl. CPC H04L 51/046; H04L 12/1813; H04L 67/10
USPC 709/206

(57) ABSTRACT

Disclosed is a computer-readable recording medium storing a set of instructions executable by a processor of a client device that is accessible by a server providing an instant messaging service. The set of instructions includes an instruction configured to detect an application installed on the client device, and an instruction configured to provide the client device with a prompt indicating that the detected application is selectable as an item of interest.

### CROSS-REFERENCE TO RELATED APPLICATION

This application claims priority to and the benefit of Korean Patent Application No. 10-2003-0078346, filed Jul. 4, 2013, the disclosure of which is incorporated herein by reference in its entirety.

### BACKGROUND

1. Field

The present disclosure relates to technology for an instant messaging service enabling client devices to exchange conversation messages through a server, and more particularly, to technology for an instant messaging service facilitating a conversation between users having a similar interest.

2. Discussion of Related Art

An instant messaging service enables users to exchange conversation messages through a network. In general, such a service has been used for users of personal computers to conveniently have a conversation, but with rapid the development of communication technologies, this service is regarded as a feature necessary even for users of mobile devices, such as a mobile communication device.

A user and other users, who are registered in a phone book of the user, use a conventional instant messaging application to participate in a conversation in a chat room. However, an instant messaging service based on a phone book is not suitable for sharing information about common interests and building social relationships while communicating on the network.

### SUMMARY

The present disclosure is directed to an instant messaging service based on items of interest to users such that users conveniently share information and opinions on the items of interest.

According to an aspect of the present disclosure, provided is a computer-readable recording medium storing a set of instructions executable by a hardware processor of a client device that is accessible to a server providing an instant messaging service, wherein the set of instructions includes an instruction configured to detect an application installed on the client device, and an instruction configured to provide the client device with a prompt indicating that the detected application is selectable as an item of interest.

According to another aspect of the present disclosure, provided is a computing device including a hardware processor and memory storing a set of instructions executable by the processor of the computing device that is accessible to a server providing an instant messaging service, wherein the set of instructions includes, an instruction configured to detect an application installed on the computing device, and an instruction configured to provide the computing device with a prompt indicating that the detected application is selectable as an item of interest.

According to still another aspect of the present disclosure, provided is an instant messaging service providing method implemented by a server configured to provide an instant messaging service, the instant messaging service providing method including: acquiring a list of chat rooms corresponding to an application selected as an item of interest among applications installed on a client device that is accessed by the server; and transmitting the acquired list to the client device.

According to still another aspect of the present disclosure, provided is a computer-readable recording medium storing a set of instructions executable by a hardware processor of a server to provide an instant messaging service, wherein the set of instructions includes, an instruction configured to acquire a list of chat rooms corresponding to an application selected as an item of interest among applications installed on a client device that is accessed by the server, and an instruction configured to transmit the acquired list to the client device.

According to still another aspect of the present disclosure, provided is a server for providing an instant messaging service, the server including: a chat room list acquiring module configured to acquire a list of chat rooms corresponding to an application that is selected from applications installed on a client device accessing the server as an item of interest; and a chat room list transmitting module configured to transmit the acquired list to the client device.

### BRIEF DESCRIPTION OF THE DRAWINGS

The above and other objects, features, and advantages of the present disclosure will become more apparent to those of ordinary skill in the art by describing in detail exemplary embodiments thereof with reference to the accompanying drawings, in which:

FIG. 1 is a drawing used to explain an instant messaging service in accordance with an exemplary embodiment of the present disclosure;

FIG. 2 is a block diagram schematically illustrating configuration of a client device of an instant messaging service in accordance with an exemplary embodiment of the present disclosure;

FIGS. 3A to 3C are each illustrating a display providing a prompt that is configured to recommend an application as an item of interest in accordance with an exemplary embodiment of the present disclosure;

FIG. 4 is a block diagram schematically illustrating configuration of a server to provide an instant messaging service in accordance with an exemplary embodiment of the present disclosure;

FIG. 5 is a flowchart showing a process performed for an instant messaging service in accordance with an exemplary embodiment of the present disclosure;

FIG. 6 is a flowchart showing another process performed for an instant messaging service in accordance with an exemplary embodiment of the present disclosure; and

FIG. 7 is a diagram illustrating an operation of determining whether an application detected in FIG. 6 performed by an instant messaging service in accordance with an exemplary embodiment of the present disclosure has already been selected as an item of interest.

### DETAILED DESCRIPTION OF EXEMPLARY EMBODIMENTS

Exemplary embodiments of the present disclosure will be described in detail below with reference to the accompanying drawings. While the present disclosure is shown and described in connection with exemplary embodiments thereof, it will be apparent to those skilled in the art that various modifications can be made without departing from the spirit and scope of the present disclosure.

Descriptions of commonly known technologies that obscure the gist of the present disclosure are omitted for clarity. The same reference numerals are used to refer to the same elements throughout the specification. Terminology described below is defined in consideration of the functions in the present disclosure and may vary according to a user's or an operator's intentions or usual practice. Thus, the meanings of the terminology used herein should be interpreted based on the overall context of the present specification.

The technical spirit of the present disclosure is determined by the appended claims, and the following embodiments are only a means to efficiently explain progressive technical features of the present disclosure to those skilled in the art to which the present disclosure belongs.

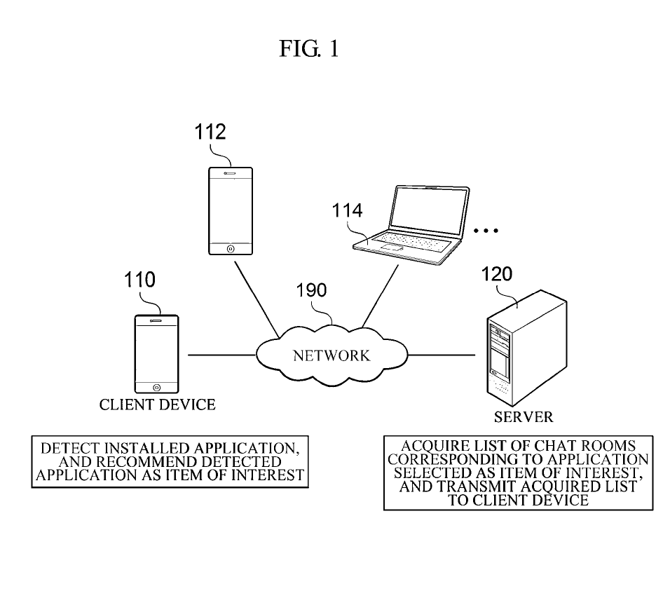

FIG. 1 is a drawing used to explain an instant messaging service in accordance with an exemplary embodiment of the present disclosure.

Referring to FIG. 1, a user of a client device 110 may have a conversation with users of other client devices 112 and 114. In detail, the user of the client device 110 may have access to a server 120 through a network 190 (for example, the Internet) and may compose a conversation message and allow the composed conversation message to be transmitted to the other client devices 112 and 114 through the server 120. Conversation messages exchanged between users of the client devices 110, 112, and 114 are transmitted and received within the context of a chat room created by the server 120. FIG. 1 illustrates examples of the client devices 110, 112, and 114. For example, the client devices 110, 112, and 114 each may be a personal/household computing device, such as a mobile phone, a smartphone, a tablet PC, a laptop computer, or a desktop computer. For example, the computing device implemented as the server 120 may be a main frame-based server computer or an open system-based server computer.

In accordance with an exemplary embodiment of the present disclosure, an instant messaging service may be equipped with improved features. Referring to FIG. 1, the client device 110 of an instant messaging service in accordance with an exemplary embodiment of the present disclosure operates such that a predetermined application is detected among applications installed on the client device 110, and the detected application is recommended to the user of the client device 110 so as to be registered as an item of interest. The server 120 of the instant messaging service in accordance with an exemplary embodiment of the present disclosure operates such that a list of chat rooms related to an application selected as an item of interest by the user of the client device 110 is acquired, and the acquired list is transmitted to the client device 110. In this manner, in accordance with an exemplary embodiment of the present disclosure, an instant messaging service enabling a conversation between users based on an item of interest is provided.

Hereinafter, various exemplary embodiments of the present disclosure will be described.

At least one application may be installed on the client device 110. The application includes a set of instructions that are executable by a computer to provide a certain service.

The client device 110 may detect some or all of the applications installed on the client device 110. For example, the application installed on the client device 110 may be detected by use of a function provided by an operating system of the client device 110. Instead of or in addition to the above configuration, an application including a certain code among applications installed on the client device 110 may be detected. The client device 110 may provide a prompt, for example, a notification message indicating that the detected application may be selected as an item of interest. The user of the client device 110 recognizes the provided prompt, and performs an input with respect to the client device 110 to select the detected application as an item of interest.

The application selected as an item of interest may be classified into at least one category according to a predetermined criterion. The server 120 acquires a list of chat rooms corresponding to the categories classified as such, and transmits the acquired list to the client device 110. The classification of categories may be performed by the client device 110, or the server 120. For such a classification, a criterion for matching each application that is selectable as an item of interest with at least one category may be maintained in the client device 110 and/or the server 120 in a predetermined form of data structure. As an example, when the client device 110 receives a select input from the user, the client device 110 notifies the server 120 of the selected application. The server 120 having received the notification recognizes at least one category corresponding to the selected application based on the predetermined criterion for matching the respective applications selectable as an item of interest with categories, and acquires a list of chat rooms (i.e., including a public chat room) belonging to the recognized category. Alternatively, in response to reception of the select input from the user, the client device 110 may notify the server 120 of at least one category corresponding to the selected application according to the above-described criterion. As another example, a notification about an application selected as an item of interest and a predetermined category corresponding to the selected application is transmitted from the client device 110 to the server 120, and the server 120 may acquire a list of chat rooms corresponding to the selected application. In addition, it will be apparent to those skilled in the art that various scenarios other than the above exist.

Meanwhile, the client device 110 may detect an application newly installed on the client device 110 after detecting an existing application. In this case, the client device 110 may selectively operate depending on whether the detected application has already been selected as an item of interest. That is, if the detected application is determined to have been selected as an item of interest, the client device 110 may not provide a prompt configured to recommend the detected application so as to be selected as an item of interest, and may not receive a list of chat rooms corresponding to the detected application from the server 120. If it is determined that the detected application has not been selected as an item of interest, the client device 110 operates in the same manner as above.

The client device 110 having received the list of chat rooms from the server 120 allows an indication of at least one of the chat rooms in the received list to be exposed on the client device 110. The indication is without limitation, and may include visualized indications. For example, as for all or some of the chat rooms in the list with respect to the application selected by the user of the client device 110 as an item of interest, a combination selected from a group including a title, an icon, IDs, names, and avatars of an administrator and/or participants, and other graphic elements may be visually provided on a predetermined region of a display of the client device 110. In this case, the number of chat rooms displayed on the client device 110 may vary with the size of the display of the client device 110, the setting of size of graphic elements (e.g., font) displayed on the client device 110, a predetermined filtering criterion for setting chat rooms that are not to be displayed on the client device 110, and/or the setting of the maximum number of chat rooms being displayed on the client device 110 at the same time. Since the user of the client device 110 may participate in the chat room by selecting a predetermined chat room displayed on the client device 110, information with regard to the selected application or a category corresponding to the selected application may be exchanged in the form of a conversation.

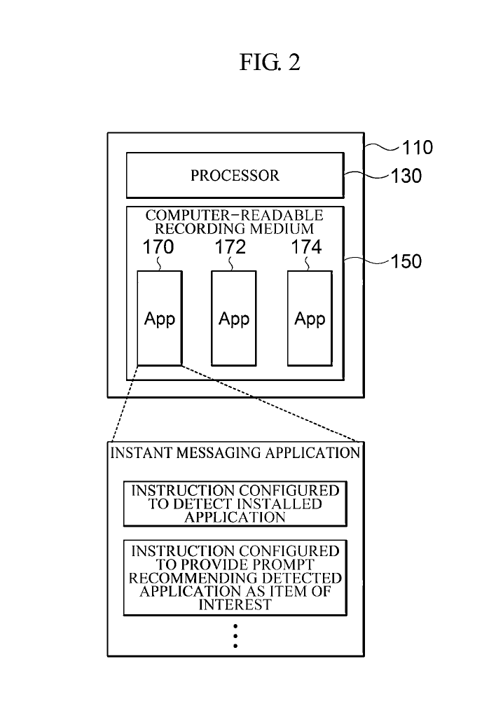

Hereinafter, the client device 110 in accordance with an exemplary embodiment of the present disclosure will be broadly described with reference to FIG. 2. The following description will be illustratively provided in relation to computer-executable instructions that may be executable on a computing device, such as the client device 110. It will be apparent to those skilled in the art that the client device 110 may be implemented as a combination of other forms of software and/or hardware.

Referring to FIG. 2, the client device 110 includes at least one processor 130 and a computer-readable recording medium 150 connected to the processor 130. The processor 130 may operate the client device 110 according to an exemplary embodiment of the present disclosure. For example, the processor 130 may be configured to execute instructions stored in the computer-readable recording medium 150, and enable the client device 110 to perform operations according to exemplary embodiments of the present disclosure when the instructions stored in the computer-readable recording medium 150 are executed by the processor 130. The computer-readable recording medium 150 may be provided inside or outside of the processor 130, and may be connected to the processor 130 in various ways that are generally known.

One or more applications 170, 172, and 174 exist on the computer-readable recording medium 150. The applications 170, 172, and 174 include a predetermined set of instructions executable by the processor 130 of the client device 110. For example, referring to FIG. 2, the application 170, entitled “an instant messaging application,” is a set of instructions configured to provide an instant messaging service in accordance with an exemplary embodiment of the present disclosure. The instant messaging application 170 may be downloaded by the user of the client device 110 from the server 120 or another server (not shown in FIG. 2), to which the instant messaging application 170 is uploaded from the server 120 or another server, and may be stored in the computer-readable recording medium 150. Meanwhile, the applications 172 and 174 may be a set of instructions configured to provide other services executable by the client device 110. For example, the application 172 may be a set of instructions to provide a casual arcade game, entitled “Everybody's Game.” In addition, the computer-readable recording medium 150 includes components (not shown) of an operating system configured to execute the applications 170, 172, and 174 on the client device 110. Such an operating system may be Android of Google, or iOS of Apple.

As described above, the instant messaging application 170 in accordance with an exemplary embodiment of the present disclosure may be stored in the computer-readable recording medium 150, and the instructions stored in the computer-readable recording medium 150 may be configured to perform operations in accordance with an exemplary embodiment described in the specification. For example, a set of instructions to implement the instant messaging application 170 may include an instruction configured to detect an application installed on the client device 110, and an instruction configured to provide the client device 110 with a prompt indicating that the detected application may be selected as an item of interest.

While the instant messaging application 170 is being executed, an instruction configured to detect an application installed on the client device 110 may be invoked to detect all or some of the applications installed on the client device 110. When the instant messaging application 170 performs an initialization task (e.g., when the instant messaging application 170 is initially installed on the client device 110), the instruction may be executed to detect an application that has already been installed on the client device 110. Meanwhile, in order to detect a newly installed application, the instruction may be executed at a certain point of time (e.g., periodically or when a predetermined event is received) while the instant messaging application 170 is being executed as a background. As described above, the detecting of the application having already been installed on the client device 110 may be achieved by use of a function provided by the operating system of the client device 110 to identify an application installed on the client device 110, for example, a function such as PackageManager of Android. Instead of or in addition to the above configuration, a certain application including a certain code configured to be inserted into the application to identify the application may be detected from the client device 110.

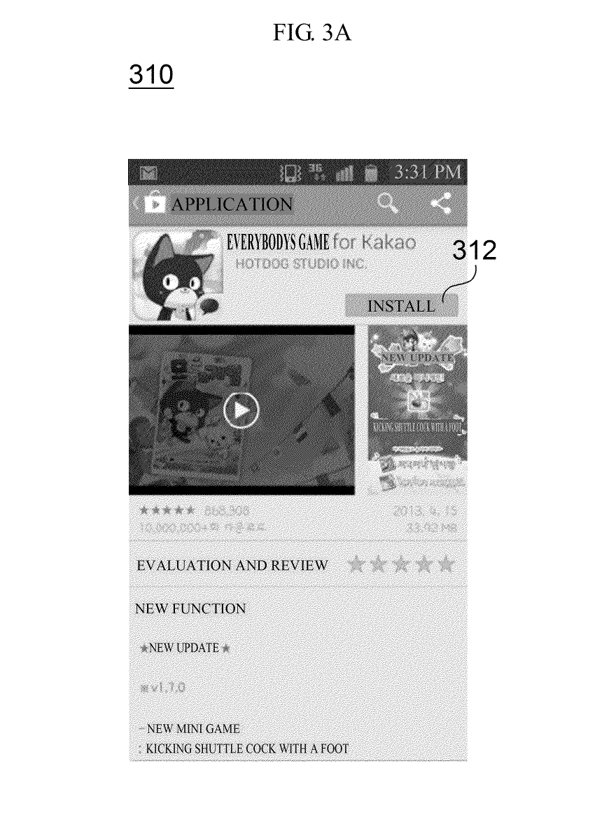

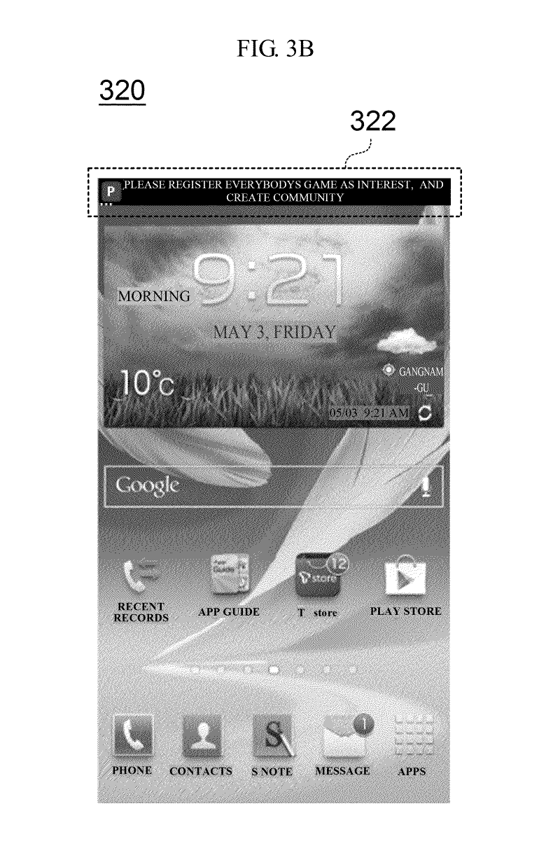

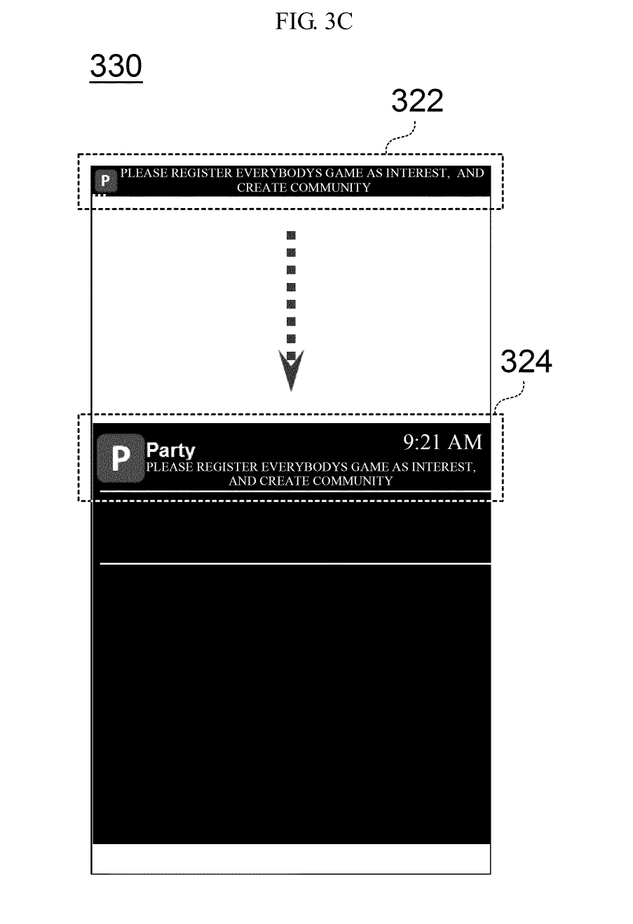

When the instruction configured to provide the client device 110 with a prompt indicating that a detected application is selectable as an item of interest is executed, a prompt recommending the detected application to be registered as an item of interest is output to a predetermined output unit (e.g., the display of the client device 110) of the client device 110. As an example, referring to FIGS. 3A-3C, the instant messaging application 170 is being executed in the background, an application newly installed on the client device 110 is detected, and a notification message recommending the detected application as an item of interest is shown on the display of the client device 110. For example, in FIG. 3A, a display 310 shows the application 172, entitled “Everybody's Game,” being installed on the client device 110 while the instant messaging application 170 is being executed in the background. When a touch input on a region 312 of the display 310 is received, the application 172 is stored in the computer-readable recording medium 150 of the client device 110. As shown in a display 320 of FIG. 3B, after the installation of the application 172 is completed, a notification message indicating that the installed application 172 is selectable as an item of interest (e.g., “Do you want to register ‘Everybody's Game’ as interest, and find a community?”) is displayed on a region 322 as a prompt. As shown in a display 330 of FIG. 3C, such a prompt may be displayed on a region 324 in a different format.

The set of instructions to implement the instant messaging application 170 may include instructions configured to implement other operations as well as the above-described instructions.

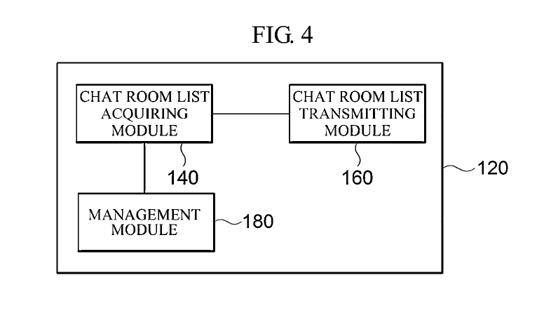

FIG. 4 is a block diagram schematically illustrating a configuration of a server to provide an instant messaging service in accordance with an exemplary embodiment of the present disclosure. The server 120, as illustrated in FIG. 4, includes a chat room list acquiring module 140 and a chat room list transmitting module 160. Also shown in FIG. 4, the server 120 may further include a management module 180.

The chat room list acquiring module 140 acquires a list of chat rooms corresponding to an application selected as an item of interest among applications installed on the client devices 110, 112, and 114 that are accessible to the server 120. As one example, the chat room list acquiring module 140 may allow the list of chat rooms to be acquired when a notification of an application selected as an item of interest and a combination selected from a predetermined category corresponding to the selected application is transmitted from the client device 110 to the server 120. As another example, the chat room list acquiring module 140 may determine whether an application detected by the client device 110 has already been selected as an item of interest, and upon determination that the detected application has already been selected as an item of interest, allows the list to be acquired.

The chat room list transmitting module 160 transmits the list acquired by the chat room list acquiring module 140 to the corresponding client device. In a predetermined chat room belonging to the transmitted list, information collected by the server 120 and related to the selected application 172 may be provided as messages for users who participate in the chat room. For example, information collected by the server 120 from the App Store of Apple or Google Play of Google with respect to the application 172, and/or information stored in a database linked with the server 120 by an administrator of the server 120 with respect to the application 172, may be provided to the users who participate in the chat room in the form of a conversation message.

The management module 180 may classify applications that may be selected as an item of interest into at least one category according to a predetermined criterion. For such a classification, a criterion for matching each application, which may be selected as an item of interest, with at least one category may be maintained in a predetermined form of data structure. In addition, the management module 180 may make respective chat rooms belonging to each category in the form of a list. Accordingly, the chat room list acquiring module 140, may acquire a list of chat rooms belonging to a category corresponding to the application if a certain application is selected as an item of interest.

Hereinafter, a correlation between each application, which is selectable as an item of interest, and a category corresponding to each application, and a list of chat rooms corresponding to an application selected by users of the client devices 110, 112, and 114 as an item of interest are illustrated.

For example, an application, entitled “Everybody's Game”, may correspond to at least one of “Everybody's Game” (category #1), “arcade game” (category #2), “casual game” (category #3), and “game” (category #4). As described above, one of any two categories may be an upper layer concept of the other, and any two categories having no inclusion relation do not need to be mutually exclusive. Chat rooms belonging to each category may be formed into a list for each category. For example, chat rooms belonging to category #1 (e.g., chat rooms #1 to #3), chat rooms belonging to category #2 (e.g., chat rooms #1 to #4), chat rooms belonging to category #3 (e.g., chat rooms #1 to #3 and #5), and chat rooms belonging to category #4 (e.g., chat rooms #1 to #6) each may be made into a list. Based on the listing by categories, a list of chat rooms corresponding to an application selected as an item of interest may be acquired. As an example, it may be assumed that an application, entitled “Everybody's Game” corresponds to category #1, and when the user of the client device 110 selects the application 172 entitled “Everybody's Game” as an item of interest, the chat room list acquiring module 140 may acquire list #1 listing chat rooms #1 to #3 belonging to category #1. As another example, it may be assumed that the application, entitled “Everybody's Game” corresponds to categories #1 to #3, and when the user of the client device 110 selects the application 172 titled “Everybody's Game” as an item of interest, the chat room list acquiring module 140 may acquire a list listing chat rooms #1 to #5 which correspond to a union of the chat rooms belonging to categories #1 to #3.

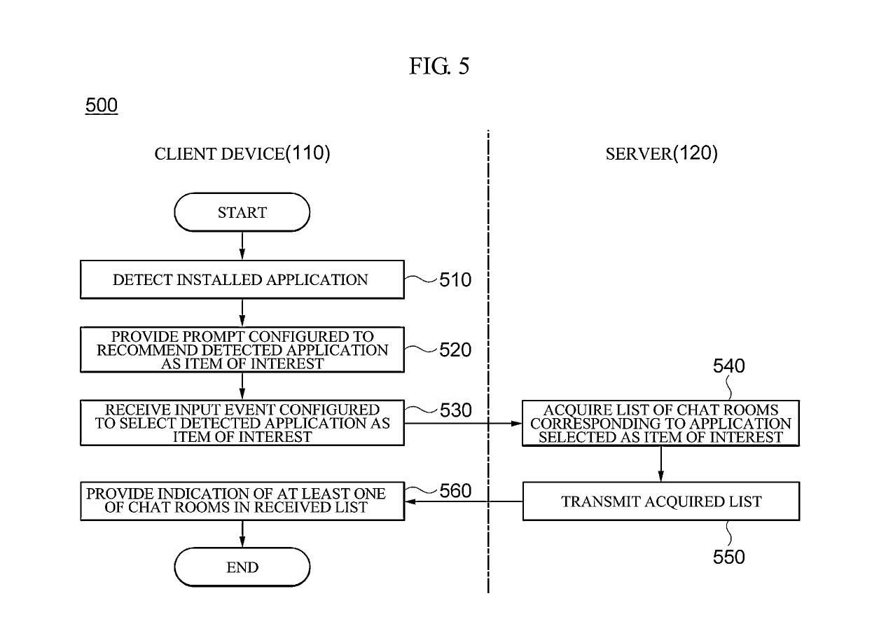

FIG. 5 is a flowchart showing a process performed for an instant messaging service in accordance with an exemplary embodiment of the present disclosure.

For example, a process 500 of FIG. 5 begins as the application 172 installed on the client device 110 is detected during an initialization of the instant messaging application 170 (e.g., during installation of the instant messaging application 170) in the client device 110 on which the application 172 is installed (510). Thereafter, the client device 110 provides the client device 110 with a prompt recommending the detected application 172 to a user as an item of interest (520). For example, prompts may be provided as the displays 320 and 330 shown in FIGS. 3B and 3C, respectively. The client device 110 receives an input of the user to select the detected application 172 as an item of interest (530). Upon reception of the input, the client device 110 may notify the server 120 of the application 172 and/or at least one category corresponding to the application 172. Upon reception of the notification, the server 120 acquires a list of chat rooms corresponding to the application 172 selected as an item of interest (540). Thereafter, the list of chat rooms is transmitted from the server 120 to the client device 110 (550). The client device 110 provides an indication of at least one of chat rooms of the received list (560). For example, text representing all or some of chat rooms in the received list may be visually exposed on the display of the client device 110. The process 500 may be performed with respect to all applications installed on the client device 110 or an application provided with a certain code in a sequential or parallel manner.

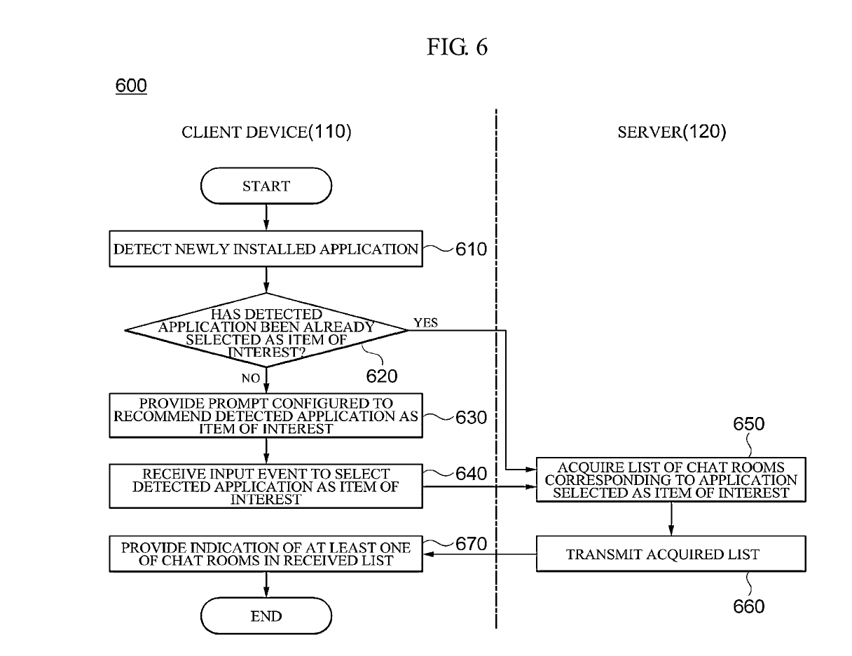

FIG. 6 is a flowchart showing another process performed for an instant messaging service in accordance with an exemplary embodiment of the present disclosure.

A process 600 of FIG. 6 begins as the application 174 newly installed on the client device 110 is detected while the instant messaging application 170, completed with installation, is being executed in the background in the client device 110 (610). After the detection, it is determined whether the application 174 has already been selected as an item of interest (620). If it is determined that the application 174 has not been selected as an item of interest, a process similar to the above process 500 continues. That is, the client device 110 provides a prompt recommending the detected application 174 to a user as an item of interest (630), and receives an input from the user to select the application 174 as an item of interest (640). Thereafter, the server 120 having received a notification of the application 174 transmitted from the client device 110 and/or at least one category corresponding to the application 174 acquires a list of chat rooms corresponding to the application 174 (650), and transmits the acquired list of chat rooms to the client device 110 (660). The client device 110 having received the list provides an indication of at least one of chat rooms in the received list (670). If it is determined that the application 174 has already been selected as an item of interest, the server 120 is allowed to acquire a list of chat rooms corresponding to the application 174, and transmit the list to the client device 110 (660). The process 600 may be performed periodically or when a certain event occurs while the instant messaging application 170 is being executed.

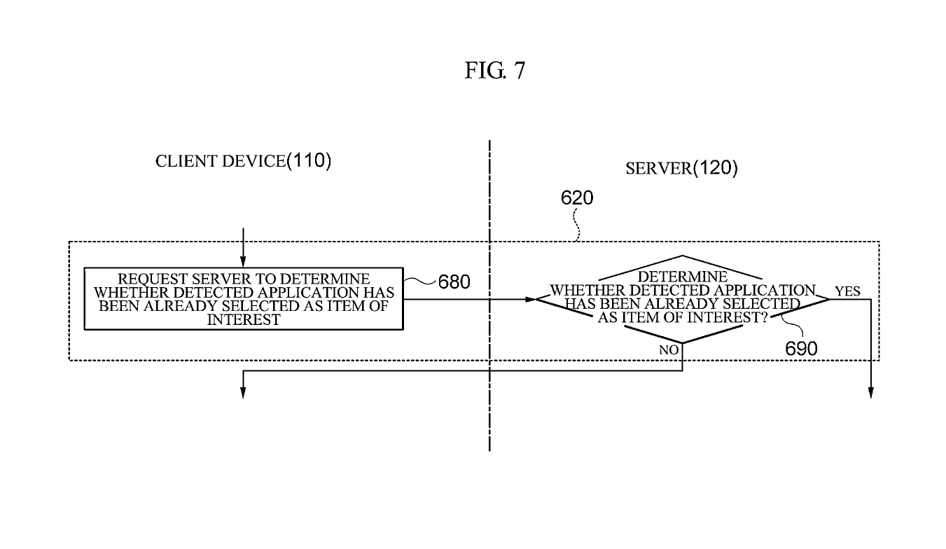

The determination 620 of the process 600 may be performed by the client device 110. As another example, as shown in FIG. 7, the server 120 may perform the determination 620, and transmit the result of the determination to the client device 110. As shown in FIG. 7, the client device 110 requests the server 120 to determine whether the detected application 174 has been selected as an item of interest (680), and the server 120 performs the determination according to the request (690). If the server 120 determines that the application 174 has not been selected as an item of interest, the server 120 notifies the client device 110 of the result of determination, and the client device 110 performs the above-described operations (630) to (670) in response to the determination. Upon determination that the application 174 has been selected as an item of interest, the server 120 acquires a list of chat rooms corresponding to the application 174 (650), and transmits the list to the client device 110 (660). In this case, the server 120 may perform the acquisition (650) and transmission (660) without notifying the client device 110 of a result of the determination.

According to the exemplary embodiments of the present disclosure, an application installed on a client device of an instant messaging service is detected and recommended to be registered as an item of interest, and a list of chat rooms corresponding to an application that is selected by a user of the client device as an item of interest is provided, thereby facilitating a social interaction on the network between users having the same or similar interests.

An exemplary embodiment of the present disclosure may include a computer-readable recording medium that stores a program configured to perform the method described herein. The computer-readable recording medium may include a program instruction, a local data file, and a local data structure, or a combination thereof. The computer-readable recording medium may be specially designed for the present disclosure or well-known and used by those of ordinary skill in the field of computer software. Examples of the computer-readable recording medium include a hardware device constructed to store and execute a program instruction, for example, magnetic media such as hard disks, floppy disks, and magnetic tapes, optical media such as CD-ROMs and DVDs, magneto-optical media such as floppy disks, read-only memories (ROMs), random access memories (RAMs), and flash memories. In addition, the medium described above may be a transmission medium such as light including a carrier wave transmitting a signal specifying a program instruction and a data structure, a metal line, and a wave guide. The program instruction may include a machine code made by a compiler, and a high-level language executable by a computer through an interpreter.

It will be apparent to those skilled in the art that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

What is claimed is:

1. A computer-readable recording medium storing a set of instructions executable by a hardware processor of a client device that is accessible to a server providing an instant messaging service,
wherein the set of instructions comprises:
an instruction configured to detect an application installed on the client device; and
an instruction configured to provide the client device with a prompt indicating that the detected application is selectable as an item of interest.

2. The computer-readable recording medium of claim 1, wherein the set of instructions further comprises:
an instruction, if the detected application is selected as an item of interest, configured to receive a list of chat rooms corresponding to the selected application from the server; and
an instruction configured to allow an indication of at least one of the chat rooms in the received list to be exposed on the client device.

3. The computer-readable recording medium of claim 2, wherein the set of instructions further comprises an instruction configured to receive an input that selects the detected application as an item of interest.

4. The computer-readable recording medium of claim 3, wherein the set of instructions further comprises an instruction, in response to reception of the input, configured to transmit at least one category corresponding to the selected application and a combination selected from the selected application to the server.

5. The computer-readable recording medium of claim 1, wherein the set of instructions further comprises an instruction configured to allow an application newly installed on the client device to be detected while an instant messaging application including the set of instructions is being executed as a background.

6. The computer-readable recording medium of claim 1, wherein the set of instructions further comprises an instruction, in response to determination that the detected application has already been selected as an item of interest, configured to notify the server of at least one category corresponding to the selected application and a combination selected from the selected application.

7. The computer-readable recording medium of claim 1, wherein the set of instructions further comprises an instruction, in response to determination that the detected application has not been selected as an item of interest, configured to allow the prompt to be provided to the client device.

8. The computer-readable recording medium of claim 1, wherein the set of instructions further comprises an instruction configured to determine whether the detected application has already been selected as an item of interest.

9. The computer-readable recording medium of claim 1, wherein the set of instructions further comprises:
an instruction configured to request the server to determine whether the detected application has already been selected as an item of interest; and
an instruction configured to receive a determination that the detected application has not been selected as an item of interest.

10. A computing device comprising:
a hardware processor; and
a memory storing a set of instructions executable by the processor of the computing device that is accessible to a server providing an instant messaging service,
wherein the set of instructions comprises:
an instruction configured to detect an application installed on the computing device; and
an instruction configured to provide the computing device with a prompt indicating that the detected application is selectable as an item of interest.

11. An instant messaging service providing method implemented by a server configured to provide an instant messaging service, the instant messaging service providing method comprising:
acquiring a list of chat rooms corresponding to an application selected as an item of interest among applications installed on a client device that is accessed to the server; and
transmitting the acquired list to the client device.

12. The instant messaging service providing method of claim 11, wherein the chat rooms corresponding to the selected application include a public chat room.

13. The instant messaging service providing method of claim 11, wherein the chat rooms corresponding to the selected application include a chat room belonging to at least one category corresponding to the selected application according to a predetermined criterion.

14. The instant messaging service providing method of claim 11, wherein the chat rooms corresponding to the selected application include a chat room in which information collected by the server and related to the selected application is provided as a message for a user who participates in the chat room.

15. The instant messaging service providing method of claim 11, further comprising allowing the list to be acquired when a notification of at least one category corresponding to the selected application and a combination selected from the selected application is received from the client device.

16. The instant messaging service providing method of claim 11, further comprising:
determining whether an application detected from the client device has already been selected as an item of interest; and
in response to determination that the detected application has already been selected as an item of interest, allowing the list to be acquired.

17. A computer-readable recording medium storing a set of instructions executable by a hardware processor of a server to provide an instant messaging service,
wherein the set of instructions comprises:
an instruction configured to acquire a list of chat rooms corresponding to an application selected as an item of interest among applications installed on a client device that is accessed by the server; and
an instruction configured to transmit the acquired list to the client device.

18. A server for providing an instant messaging service, the server comprising:
a chat room list acquiring module configured to acquire a list of chat rooms corresponding to an application that is selected from applications installed on a client device accessing the server as an item of interest; and
a chat room list transmitting module configured to transmit the acquired list to the client device.

19. The server of claim 18, wherein the chat rooms corresponding to the selected application include a public chat room.

20. The server of claim 18, wherein the chat rooms corresponding to the selected application include a chat room belonging to at least one category corresponding to the selected application according to a predetermined criterion.

21. The server of claim 18, wherein the chat rooms corresponding to the selected application include a chat room in which information collected by the server and related to the selected application is provided as a message for a user who participates in the chat room.

22. The server of claim 18, wherein the chat room list acquiring module allows the list to be acquired when a notification of at least one category corresponding to the selected application and a combination selected from the selected application is received from the client device.

23. The server of claim 18, wherein the chat room list acquiring module determines whether an application detected from the client device has already been selected as an item of interest, and in response to determination that the detected application is already selected as an item of interest, allows the list to be obtained.
